(19) United States
(12) Patent Application Publication
(10) Pub. No.: US 2010/0036706 A1
(43) Pub. Date: Feb. 11, 2010

(54) QUEUE EARLY WARNING SYSTEM

(75) Inventor: Peter Geoffrey Cohen, Victoria (AU)

Correspondence Address: KNOBBE MARTENS OLSON & BEAR LLP, 2040 MAIN STREET, FOURTEENTH FLOOR, IRVINE, CA, 92614, US

(73) Assignee: BEONIC CORPORATION PTY LTD, Toorak, Victoria (AU)

(21) Appl. No.: 11/993,217

(22) PCT Filed: Jun. 23, 2006
(86) PCT No.: PCT/AU2006/000877

§ 371 Date: Sep. 29, 2009

(30) Foreign Application Priority Data
Jun. 24, 2005 (AU) 2005903330

(51) Int. Cl. G06Q 10/00; G06Q 50/00; G06N 5/02

(52) U.S. Cl. 705/9; 705/10; 705/7; 706/52

(57) ABSTRACT

A method and apparatus for rostering staff in a service region such as a supermarket (10) in which required staff numbers for a checkout (16), for instance, depends upon demand for that function at a selected time. The method including the steps of determining (18, 30) the number of persons entering at least one area in the region (12, 14), calculating the estimated time each person will spend in that area dependant upon selected factors and predicting future demands for staff for a selected portion of time ahead. The required number of staff can then be supplied to the checkout in time to cater for the predicted demand or redeployed to another area.

### FIELD OF INVENTION

This invention relates to systems for efficient staff deployment and rostering in commercial and public places such as banks, shops, supermarkets, department stores, libraries and the like where service is provided to customers or the public.

### BACKGROUND TO THE INVENTION

This invention will be generally discussed in relation to staff management for staff at checkouts, cash registers in supermarkets and points of customer service in retail space but its application is not so restricted and can relate to any situation where staff numbers must be manipulated to cater for such public or customer demand.

Staff rostering or human resource management systems are used to schedule staff resources to the shop floor generally at least a week and up to a month in advance. This gives staff reasonable notice of their pending shifts. This is conducted using strict guidelines within constraints imposed by the company's business guidelines, employee awards and other regulations. The basis of these systems is usually historical information such as sales information which is used to project sales and therefore staff numbers into the future. Management also use this to ensure payroll costs are kept within budgeted levels. Once checkout and customer service staff have been rostered on, management can usually only make productivity adjustments by allocating these staff to other duties. Other than cash transactions, their duties extend to include customer service assistance, packing, cleaning, attendance to accidents and administration.

This number of checkout staff needed is usually based on previous sales and items sold for a particular time of the day. The numbers are designed to optimise customer service levels, and open the appropriate number of checkouts for expected arrival of customers.

The chances of predicting the customer service demand and checkout numbers is not efficient and it is becoming more difficult due to the competitive pressures of real-time marketing. Consumers are becoming less predictable because they are more empowered to make choice, last minute decisions and change. This can quickly destroy the possibility of a successful customer service balance.

Staff rostering systems are used to allocate an appropriate level of staff to meet the needs of customer demand whilst management are keeping these levels to a minimum to keep the operation of the store viable. Changes are made to take into account likely fluctuations from day-to-day and week-to-week. However, they simply cannot predict when and how many people are likely to visit. Large numbers of visitors entering the store will immediately create an imbalance of customer service if there are not enough staff on the floor to service these needs. Too many staff will increase operational costs. Too few will lead to customer frustration and dissatisfaction.

It is the object of the present invention to use real-time information about the number of customers who have just walked into the store or department to predict how may of these people are likely to want service and generate a sale and the delay until that service will be required. Ultimately, this system is designed to achieve overall improvement in store productivity, economics, customer service levels and customer satisfaction.

### BRIEF DESCRIPTION OF THE INVENTION

In one form therefore although this may not be the only or broadest form the invention is said to reside in a method of deploying rostered staff in a service region in which required staff numbers for a particular function depend upon demand for that function at a selected time, the method including the steps of;
determining the number of persons entering at least one area in the region;
calculating the estimated time each person will spend in that area dependant upon selected factors;
a predicting future demands for staff for a selected portion of time ahead, and
deploying staff to meet the predicted demand
   whereby the required number of staff can be supplied to the service region in time to cater for the predicted demand.

The step of predicting future demands can include the steps of at least one of:
a predicting visitor numbers in selected areas;
predicting customer service level requirements;
predicting checkout requirements to meet customer demand; and
predicting staff requirements to meet customer demand.

Preferably the service region is a department store, a supermarket or any other region where service provision can be varied dependent upon demand for those services.

The selected factors can include one or more of;
time of day;
day of the week;
type of demand in the area;
predicted demand factors;
historically determined factors;
empirically determined factors;
expected variable demand profile;
acceptable waiting time in queues to have the demand satisfied;
expected quantum of demand for the time of day and day of week;
tender time at the cash register; and
customer interaction time.

The method can further include the step of displaying the required numbers to allow management to take any required action or it could be automated to deploy staff to an area using a paging system.

The step of displaying the required numbers to allow management to take any required action can include displaying the number as an increment or decrement from that of staff actually present at the selected time. Alternatively the display can comprise a display of the rostered staff, actual staff present at the selected time and predicted staff requirement and the display can comprise a display of the numbers both graphically and numerically.

The method can further include the step of recording the calculations and actions made to enable management to perform post analysis.

In one embodiment the particular function can be a cash register or checkout in a shop.

In one embodiment the service region can be divided into a plurality of sub-regions and numbers entering each sub-region may be determined and the step of calculating the estimated time each person will spend in that sub-region is dependent upon selected factors for that sub-region whereby the step of predicting future demands for staff is a composite of the estimated times for each of the sub-regions.

The sub-regions can be departments of a department store or an aisle or region of a supermarket.

In an alternative form the invention comprises a method of rostering staff in a supermarket in which required staff numbers for a cash register or checkout function depend upon the amount of persons requiring the cash register or checkout function at a particular time, the method including the steps of;
determining the number of persons entering the supermarket or at least one area in the supermarket;
calculating the estimated time each person will spend in the supermarket or that area dependent upon selected factors;
predicting demands for staff numbers for a cash register or checkout function for a selected portion of time into the future based upon the estimated time each person will spend; and
displaying the required numbers to allow management to take any required action;
   whereby the required number of staff can be supplied to the cash register or checkout function in time to cater for the predicted demand.

The step of displaying the required numbers can include the step of displaying the numbers both graphically and numerically.

The method can further include the step of monitoring where people are at a selected time in a service region or a service sub-region to assist with predicting current and future demand in the region and sub region.

In an alternative form the invention comprises an early warning system for supermarket checkout management comprising;
a traffic counting system to determine numbers of persons entering the supermarket;
a computing system to calculate the expected residence time in the supermarket of hie persons entering the supermarket dependent upon selected factors and to predict the time until those persons will reach a checkout;
a display and/or paging arrangement to indicate the required staff numbers at a checkout for a selected period of time into the future based upon the calculated expected residence time;
   whereby supermarket checkout management can roster staff to cater for the predicted numbers going forward in time.

In one embodiment the selected factors include one or more of;
time of day;
day of the week;
type of goods or service available in the area;
predicted demand factors;
a historically determined factors;
empirically determined factors;
expected purchasing profile;
acceptable waiting time in queues at the checkout or cash register;
expected basket size for the time of day and day of week; and
tender time at the checkout.

Preferably the display comprises a display of the actual staff present at the selected time and a number being an increment or decrement from the number of staff actually present and also the display can comprise a display of the numbers both graphically and numerically.

In one embodiment the traffic counting system comprises a plurality of traffic counting devices, each traffic counting device determining traffic into particular sub-regions or all of the space within the supermarket and the computing system to calculate the expected residence time in the supermarket of the persons entering the supermarket or leaving a particular department is adapted to calculate the time in each sub-region dependent upon selected factors for that sub-region and to predict a composite time until those persons will reach a checkout. The purpose of this is to accurately establish the number of people that is likely to reach the checkout or customer service staff.

It will be seen that by this invention a method and apparatus is provided which monitors the number of people entering the store and records this information in a database for either real-time or historical analysis. By manipulating and comparing the captured data with the stores sales and staffing activity, the system can provide information about:
Visitor traffic flow numbers;
Occupancy;
Sales conversion;
Basket size by department;
Staff allocation;
Idle Time;
Tender time;
Transactional Time, and
Queue length preceding this.
   preferably it is possible for the system to perform real time analysis of an entire store.

The ongoing measurement of this information is designed to aid management to make better decisions for the purposes of one or more of:
Improved customer satisfaction;
Greater customer loyalty;
Improved staff communication;
Greater staff involvement in customer service planning;
More balanced staff numbers with customer service levels.
Improved layout;
Greater cross selling of products;
Increased basket size;
More frequent shopper visits;
Greater sales conversion by department; and
Greater profitability.

The system according to the present invention may also include the addition of traffic counting sensors in various other parts of the retail premises to establish how far persons are from the cash register positions to assist with improving accuracy. By this arrangement it is possible for the entire shop/environment to be monitored in real time. This may for instance include detector systems to cover the entire floor space of a retail space for instance to establish the exact number of people in occupation in various departments, floors and sections within the premises.

Each of the detectors may include a recognition device and staff may carry transponders for the recognition device so that the system can track staff and distinguish staff from customers to assist with improving the accuracy of customer service and queuing demand prediction. The recognition devices may for instance be radio frequency identification devices (RFID) to more appropriately match the numbers of staff to the numbers of people in the detector space.

A larger store such as a department store may be divided into a plurality of sub-regions and the number of staff and customers in each sub-region being determined to assist with deciding whether more staff should be deployed in the sub-region to meet the expected customer demand. Expected customer demand may include a requirement for information about products in that sub-region. A decision as to whether more staff should be deployed in a particular sub-region may include moving staff from a sub-region where demand is low to a sub-region where demand is higher.

This then generally describes the invention but to assist with understanding reference will now be made to preferred embodiments of the invention with the assistance of the accompanying drawings.

In the drawings:

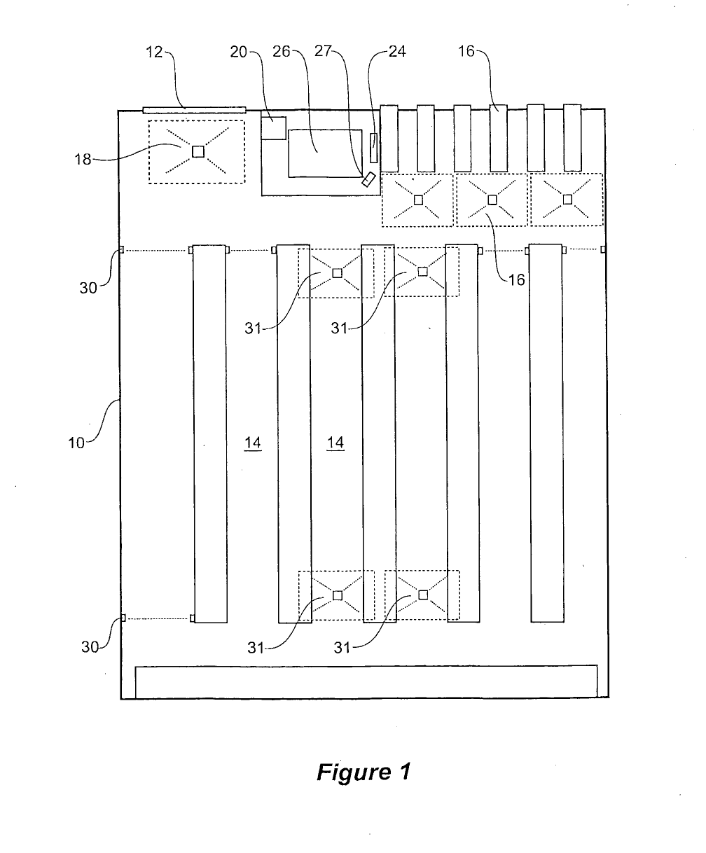

FIG. 1 shows a schematic layout of a supermarket using a staff early warning system according to one embodiment of the present invention;

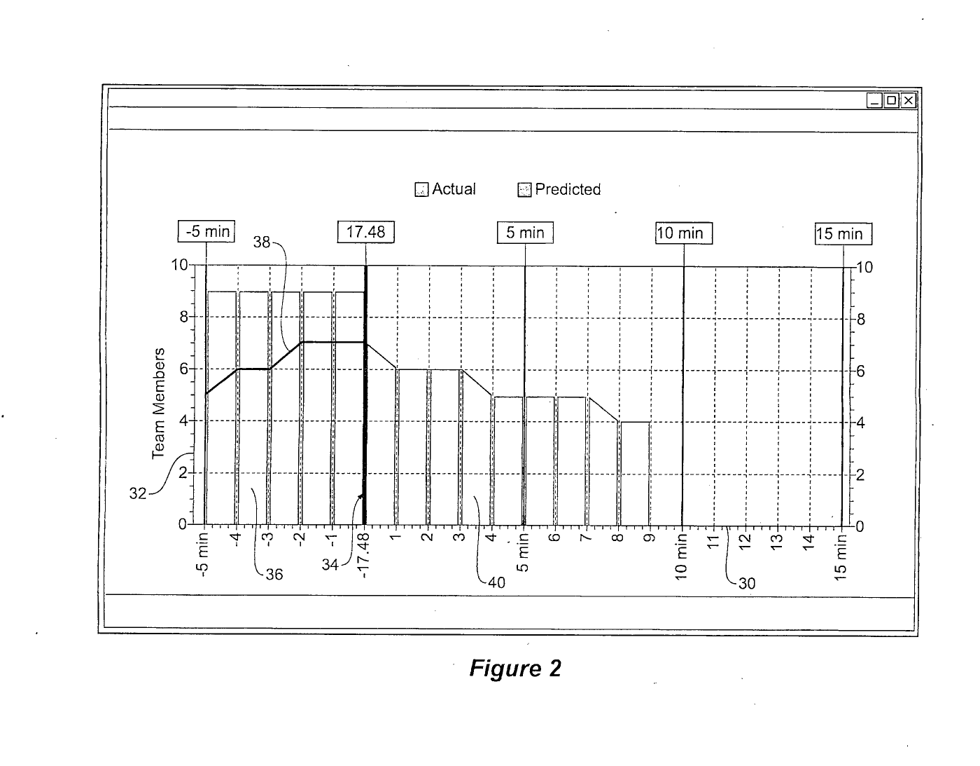

FIG. 2 shows a typical graphical display for an early warning system according to the present invention;

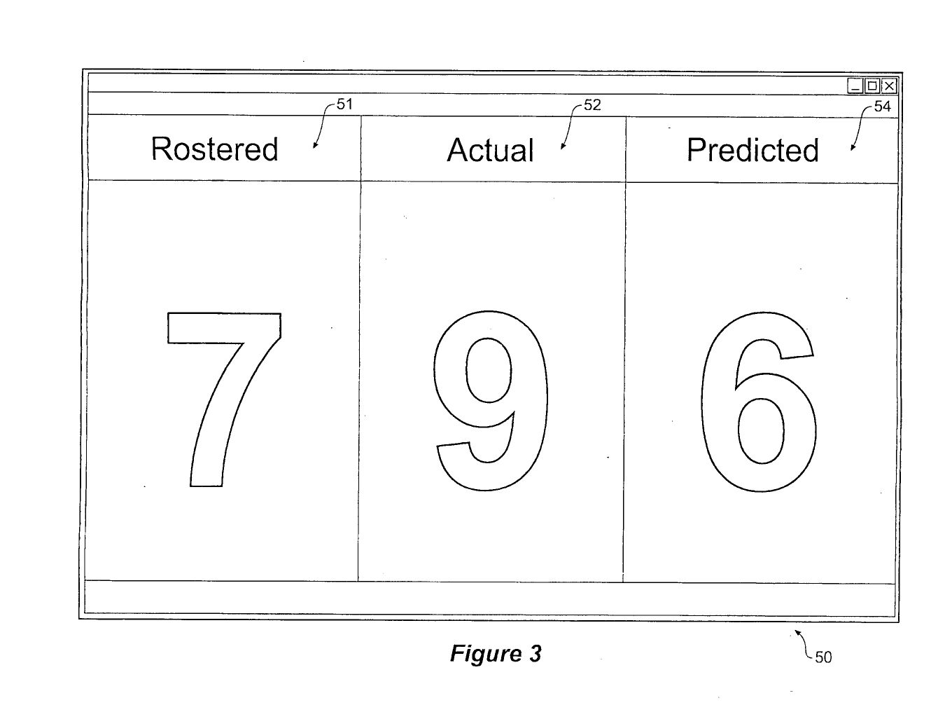

FIG. 3 shows a typical numerical display for an early warning system according to the present invention; and

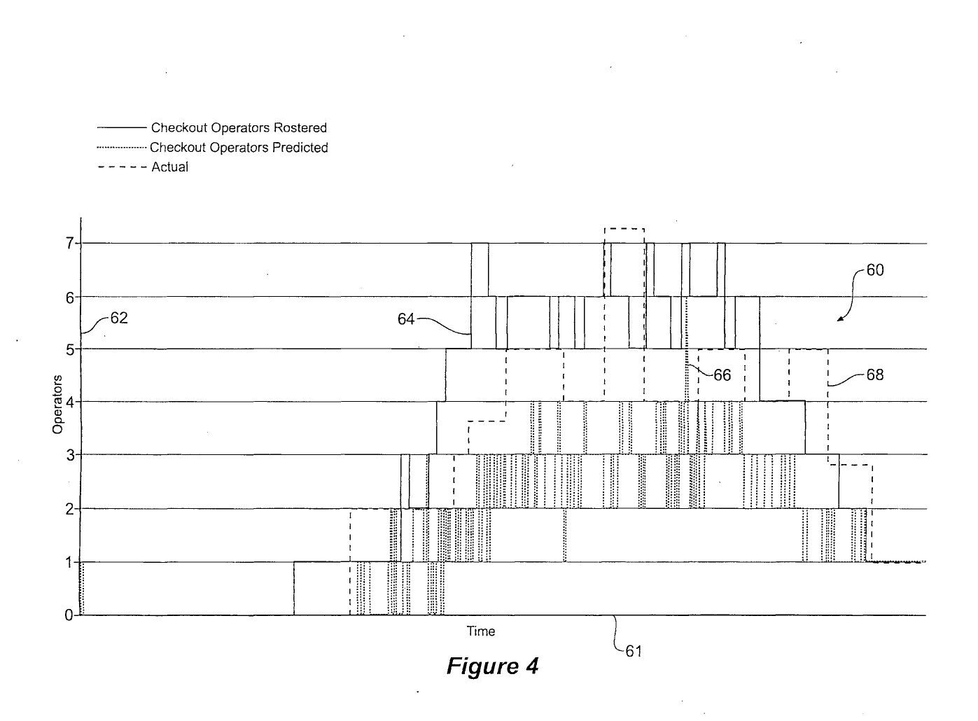

FIG. 4 shows a typical analysis over a day of staff rostered to staff predicted and actual staff;

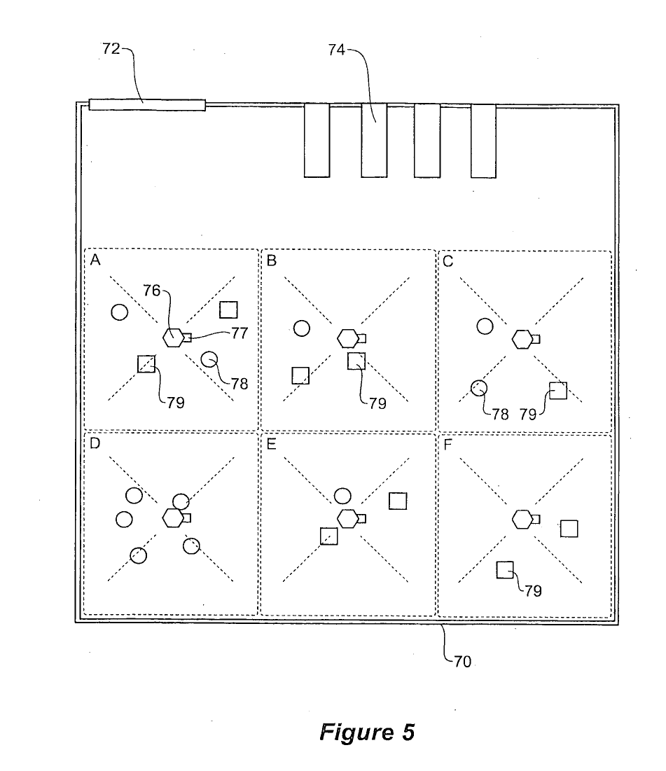

FIG. 5 shows a schematic view of a department store including sub-regions incorporating the early warning system of the present invention; and

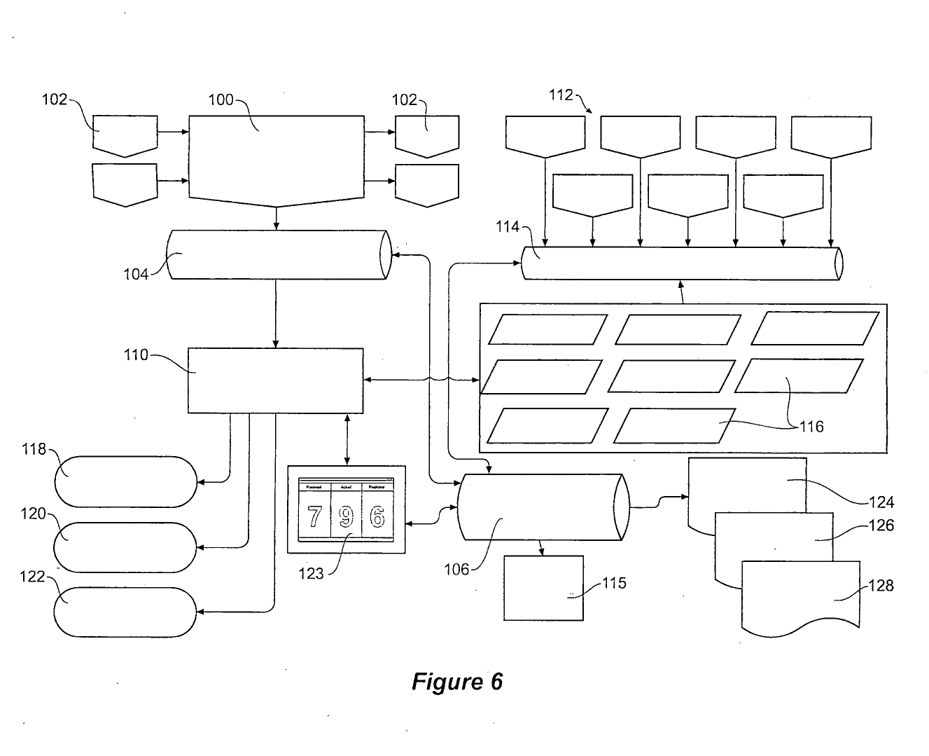

FIG. 6 shows a schematic flow sheet for a queue early warning system according to the present invention.

Now looking more closely at the drawings it will be seen that in FIG. 1 there is shown a schematic layout of a supermarket using a queue early warning system according to one embodiment of the present invention.

The supermarket 10 shown schematically in FIG. 1 has an entrance 12 leading to a number of aisles 14 stocking goods required by a customer. After completion of selection of goods the customer goes to a checkout 16 in a bank of checkouts to pay for goods. The number of persons entering the supermarket are counted by means of an overhead traffic counter system 18.

Australian patent specifications Nos. 699910 and 760298 describe traffic counting/tracking systems and the teaching of these patent specifications is incorporated in their entirety herein by reference.

Information from the overhead traffic counter 18 is passed to processor 20 which calculates how long a customer who has just entered the store is likely to stay in the store dependent upon a number of factors and then displays on display 24 in the management station 26 of the supermarket an indication of expected demand at the checkouts in a selected period of time into the future. The selected period of time into the future may for instance be the next 15 or 30 minutes. A supervisor in the management station 26 crux then use pager 27 to call for more checkout staff or to instruct excess staff a checkouts to perform other duties.

The factors which may be used to determine the expected demand at the checkout may include:
time of day;
day of the week;
type of goods or service available in the area;
predicted demand factors;
historically determined factors;
empirically determined factors;
expected purchasing profile;
demographic information;
competitor intelligence;
sales forecasts;
staff number constraints (minimum and maximum allowable);
promotional activity;
acceptable waiting time in queues at the checkout or cash register;
expected basket size for the time of day and day of week; and
other factors and variables that are likely to have an impact on customer visitation levels.

It is likely, however, that persons going to some parts of the store may take longer than when they go to other parts of the store and further at different times of the day and different days of the week people may spend a longer time in the store on average or a shorter time on average. For instance it might be expected that persons entering the store early on a Monday morning may be expected to spend a short time and buy only a few goods and present to the checkout within a few minutes of entering the store. At another time, such as on a Saturday morning, people may be expected to do a longer shop and to purchase a greater number of goods and therefore will not present themselves to the checkout for some longer time, perhaps 15 to 20 minutes, and the amount of time that the checkout operator will take to checkout their goods will be longer. In such a situation these factors are taken into account so that on the display there may be indicated that in 20 minutes time there will need to be two extra checkouts manned to cater for the demand without having the customers waiting too long at the checkout.

It is also possible that persons entering different parts of a store may take longer to select goods than persons entering other parts of the store. There are, therefore, provided sub-region traffic counters 30 and 31 at the entrance to each of the aisles so that persons entering a particular aisle or leaving a particular aisle can be counted. Traffic counters 30 may be a beam type counter and traffic counter 31 may be an overhead type spatially aware sensor that monitors the whereabouts of each person and object very accurately in a coordinated X,Y,Z position. Sensor devices may be placed at one end or both ends of a aisle. Information from these sub-region counters is passed to the processor 20 and a composite estimate of the time the customer is likely to present to a checkout is made and again the display 24 can be used to indicate future staffing demands.

The display 24 at the management station 26 indicating the number of checkout operators necessary going forward in time may be graphical or numerical.

FIG. 2 shows a possible graphical display of staffing requirements according to one embodiment of the invention. In FIG. 2 it will be seen that time appears on the X axis 30 on the graph and number of team members expected appears on the Y axis 32 of the graph. Current time is indicated by the line 34. Before the current time the bars 36 show the number of staff members working at checkouts. The line 38 shows the predicted demand for that period. After the current time 34 the vertical bars 40 show the number of staff members predicted to be necessary to be working at checkouts at selected times into the future. It can be seen for instance that between 17:43 and 17:48 there were nine staff working and that after that time it is predicted that the demand will fall from seven down to four in the next nine minutes. A staff manager can allocate persons to other duties in that period.

FIG. 3 shows a numerical display of the staffing at checkouts. In the display 50 the left hand part 51 of the display entitled “Rostered” shows the number of people rostered to be working at the checkout during a selected period of time, being 7 persons. The central portion 52 of the display 50 entitled “Actual” shows the number of persons actually working at the checkout during the selected period of time, in this case being nine persons. The prediction system according to the present invention on the right hand side 54 entitled “Predicted” of the display 50 indicates that in fact six are required in the next period of time. A store manager may for instance decide to take three persons off the checkout and put them onto some other job in the store until such time as more staff are required.

It will be realised that the number of factors which the computer may take into account can be varied. The factors may include the time of the day, the day of the week, the type of goods or services which may be sold in the supermarket and hence the time it takes to complete a selection of such a purchase as well as historically and empirically determined factors such as what customers might be expected to purchase at any time. As indicated earlier their purchasing profile may be variable at different times of the day or week and basket sizes may be different at different times of the day or of the week. Also taken into account may be what management thinks is an acceptable time for a customer to be waiting in a queue. The system according to the present invention makes use of the types of information discussed above but marries it with data relating to the actual traffic entering the supermarket which may be due to external factors such as the weather, local events and the like to assist a store manager to provide optimal staffing levels.

Also available, according to the present invention, may be an overall graphical analysis for a period of time, such as for a day. Such analysis 60 is shown in FIG. 4. In this embodiment it will be seen that the horizontal scale 61 indicates the time of day at one minute intervals and the vertical scale 62 indicates a number of checkout operators at a particular time. It will be noted that for a first period of time there was no checkout persons rostered and then during the day up to seven persons were rostered as shown by the solid line 64.

The dotted line 66 shows the number of operators predicted to be necessary at a particular time according to the present invention. It will be particularly noted, for instance, that while a seventh operator was operating at several times during the day there was no time in fact where that operator was in fact necessary and further much of the time the fourth, fifth and sixth operators were idle or not necessary. Management may decide for instance, that at times where the fourth and fifth operators were necessary it may be more economic to allow customers to wait slightly longer rather than to put on the extra staff members. The dashed line 68 indicates the actual staffing used.

This type of longer term analysis of actual and predicted staffing may be used to refine the empirically determined factors which could lead to more accurate predictions in the future.

FIG. 5 shows a schematic view of a department store 70 with an entrance 72 and a number of checkouts 74. The store is divided into a number of sub-regions A, B, C, D, E and F. In each region there is a detection system 76 to determine the number of persons in that region. There is also a radio frequency identification device (RFID) 77 associated with the detection system 76 in each sub-region A, B, C, D, E and F. In each region there are customers 78 (indicated by circles) and staff 79 (indicated by squares). Each of the staff carry a transponder 80 for the RFID and hence the system can distinguish between staff 79 and customers 78 in the sub-regions. The detection system 76 will then determine total numbers of staff in the area and the RFID system 77 will supply information on the number of staff in the sub-region so that the number of customers can be calculated. In the sub-region D for instance there are 5 customers but no staff while in the region F there are two staff and no customers. A store manager may therefore direct a staff member or staff members to the region D to assist customers with their enquiries.

FIG. 6 shows a schematic flow-sheet for a queue early warning system according to the present invention.

In this embodiment an event logger 100 accepts traffic information from a series of sensors 102 in various parts of a supermarket for instance. The sensors may be placed at an entrance doorway, at each aisle in the supermarket and at the queues at the checkouts of the supermarket. A total number of visitors in the supermarket and people queuing is calculated at 1.04 and stored as raw data in the database 106. The total number of visitors in the supermarket and people queuing is also supplied to the queue early warning module 110.

At the same time data from checkouts 112 is collated in a checkout database 114 and supplied to the database 106. Human resource information 115 is also supplied to the database 106.

The queue early warning module 110 also accepts data from the range of parameters determined empirically or otherwise such as the total number of cash registers, estimated item transaction time, scan transaction time, customer transaction time, busy time, idle time, basket size and rostered staff. From all of these along with the total number of visitors a calculation is made to provide queue early warning data. The queue early warning data can include a live action display 118 giving a warning of what will be needed in the next few minutes, an over the horizon warning 120 of what staff will be needed in the next 30 minutes or some other pre-determined time and can activate a paging system 122 if more staff are required that actually present. A numerical display 123 of rostered, actual and predicted staff numbers for the checkout is also provided.

The database 106 can also provide management reports being a rostering productivity improver 124, a labour management report 126 and a roster versus actual versus predicted report 128.

It will be seen that according to the various embodiment of the present invention the system will predict the number of customers that are likely to be waiting at the checkout in advance by calculating the likelihood of them making a purchase from the time they enter the store. If a decision to purchase has been made, they will need to go to a checkout to be served. Any abnormal influx of people entering the store will ultimately lead to congestion if there is not enough checkouts open or there are not enough staff members to serve the customers.

Information from the demand prediction system and staff rostering system is married with the information provided by the traffic monitoring system of entering the store or entering part of the store to determine whether enough people are scheduled in time. The system then calculates a likely assessment in predetermined increments (for instance, 5 minute intervals) to determine whether there is sufficient staff at checkouts over a designated period to meet expected customer demand. These calculations are made in real time at the store and recalculated every minute as the information is provided. If an imbalance is predicted, the customer service manager will be notified with a positive or negative warning of either over or under staffing at checkouts.

This can be done both graphically and numerically. This information is also stored in the database for later retrieval and analysis.

The system is designed to add value to an existing customer monitoring installation or run as a stand alone application for its sole purpose.

Throughout this specification various indications have been given as to the scope of the invention but the invention is not limited to any one of these but may reside in two or more of these combined together. The examples are given only for illustration and not for limitation.

1. A method of deploying rostered staff in a service region in which required staff numbers for a particular function depend upon demand for that function at a selected time, the method including the steps of;
determining the number of persons entering at least one area in the region;
calculating the estimated time each person will spend in that area dependant upon selected factors;
predicting future demands for staff for a selected portion of time ahead, and
deploying staff to meet the predicted demand
whereby the required number of staff can be supplied to the service region in time to cater for the predicted demand.

2. A method as in claim 1 wherein the step of predicting future demands includes the steps of at least one of:
assessing person numbers in selected areas;
setting customer service level requirements; and
setting cash register staffing requirements to meet customer demand.

3. A method as in claim 1 wherein the service region is a department store or a supermarket.

4. A method as in claim 1 wherein the selected factors include one or more of;
time of day;
day of the week;
type of demand in the area;
predicted demand factors;
historically determined factors;
empirically determined factors;
expected variable demand profile;
acceptable waiting time in queues to have the demand satisfied;
expected quantum of demand for the time of day and day of week;
tender time at the cash register; and
customer interaction time

5. A method as in claim 1 further including the step of displaying the required staff numbers for the particular function whereby to allow management to take any required action.

6. A method as in claim 5 wherein the step of displaying the required staff numbers includes displaying the number as an increment or decrement from that of staff actually present at the selected time.

7. A method as in claim 5 wherein the step of displaying the required staff numbers includes using a paging system to deploy staff to an area.

8. A method as in claim 1 wherein the particular function is a cash register or checkout in a shop.

9. A method as in claim 1 wherein the service region is divided into a plurality of sub-regions and numbers entering each sub-region are determined and the step of calculating the estimated time each person will spend in that sub-region is dependent upon selected factors for that sub-region whereby the step of predicting future demands for staff is a composite of the estimated times for each of the sub-regions.

10. A method as in claim 9 wherein the sub-regions comprise departments of a department store or aisles or region of a supermarket.

11. A method as in claim 1 further including the step of recording the calculations and actions made to enable management to perform post analysis.

12. A method of rostering staff in a supermarket in which required staff numbers for a cash register or checkout function depend upon the amount of persons requiring the cash register or checkout function at a particular time, the method including the steps of;
determining the number of persons entering the supermarket or at least one area in the supermarket;
calculating the estimated time each person will spend in the supermarket or that area dependent upon selected factors;
predicting demands for staff numbers for a cash register or checkout function for a selected portion of time into the future based upon the estimated time each person will spend; and
displaying the required numbers to allow management to take any required action;
whereby the required number of staff can be supplied to the cash register or checkout function in time to cater for the predicted demand.

13. A method of rostering staff as in claim 12 wherein the step of displaying the required numbers includes the step of displaying the numbers both graphically and numerically.

14. An early warning system for supermarket checkout management comprising;
a traffic counting system to determine numbers of persons entering the supermarket;
a computing system to calculate the expected residence time in the supermarket of the persons entering the supermarket dependent upon selected factors and to predict the time until those persons will reach a checkout;
a display arrangement to indicate the required staff numbers at a checkout for a selected period of time into the future based upon the calculated expected residence time;
whereby supermarket checkout management can roster staff to cater for the predicted numbers going forward in time.

15. An early warning system as in claim 14 wherein the selected factors include one or more of;
time of day;
day of the week;
type of goods or service available in the area;
predicted demand factors;
historically determined factors;
empirically determined factors;
expected purchasing profile;
acceptable waiting time in queues at the checkout or cash register;
expected basket size for the time of day and day of week; and
tender time at the checkout

16. An early warning system as in claim 14 wherein the display comprises a display of the actual staff present at the selected time and a number being an increment or decrement from the number of staff actually present and the display comprises a display of the numbers both graphically and numerically.

17. An early warning system as in claim 14 wherein the display comprises a display of the rostered staff, actual staff present at the selected time and predicted staff requirement and the display comprises a display of the numbers both graphically and numerically.

18. An early warning system as in claim 14 wherein the display comprises a paging system to enable staff to be deployed to an area where customers are waiting or queuing.

19. An early warning system as in claim 14 wherein the traffic counting system comprises a plurality of traffic counters, each traffic counter determining traffic into particular sub-regions or all of the space within the supermarket and the computing system to calculate the expected residence time in the supermarket of the persons entering the supermarket or leaving a particular department is adapted to calculate the time in each sub-region dependent upon selected factors for that sub-region and to predict a composite time until those persons will reach a checkout.

20. An early warning system as in claim 14 wherein each of the detectors includes a recognition device for staff within a service region and staff in that region carry transponder for that recognition device whereby to track staff and distinguish staff from customers to assist with improving the accuracy of customer service and queuing demand prediction.

21. An early warning system as in claim 20 wherein recognition device comprises a radio frequency identification devices (RFID).
